(19) United States
(12) Patent Application Publication
(10) Pub. No.: US 2024/0283671 A1
(43) Pub. Date: Aug. 22, 2024

(54) COMMUNICATION METHOD, COMMUNICATION TERMINAL, AND PROGRAM

(71) Applicant: NIPPON TELEGRAPH AND TELEPHONE CORPORATION, Tokyo (JP)

(72) Inventor: Shunichi SEKO, Tokyo (JP)

(21) Appl. No.: 18/571,896

(22) PCT Filed: Jul. 8, 2021
(86) PCT No.: PCT/JP2021/025812

§ 371 Date: Dec. 19, 2023

(51) Int. Cl. H04L 12/18; G06V 10/70; G06V 20/40; G06V 40/16; G10L 25/63

(52) U.S. Cl. CPC H04L 12/1831; G06V 10/70; G06V 20/40; G06V 40/174; G10L 25/63

(57) ABSTRACT

A communication method executed by a communication terminal capable of making a call with another communication terminal in another base includes: acquiring data related to a motion of a specific user from the motion of the specific user; detecting data of a specific unconscious emotion portion in which an unconscious emotion of the specific user has been expressed from the data related to the motion of the specific user; estimating a reaction of the specific user on a basis of the data of the specific unconscious emotion portion detected by use of a reaction estimation model for estimating a reaction of a predetermined user with respect to data of a predetermined unconscious emotion portion in which an unconscious emotion of the predetermined user has been expressed; and transmitting reaction estimation result information related to the estimated reaction of the specific user to said another communication terminal.

### TECHNICAL FIELD

The present disclosure relates to a communication method, a communication terminal, and a program.

### BACKGROUND ART

In recent years, a communication system that performs a remote conference or the like has become widespread. In this communication system, an invention has been proposed in which a situation of a user on another side can be known by an icon in addition to a call between users (see Patent Literature 1).

In addition, in a remote conference, a listener often turns off video and audio to prevent inhibition of communication caused by line compression, noise, and the like, but this causes a trade-off problem that it is difficult for a speaker to grasp a reaction of the listener.

However, as illustrated in FIG. 10, reaction icons each indicating a reaction of a user are prepared, and thus the speaker can grasp the reaction of the remote listener by the listener transmitting information indicating a reaction icon selected at any timing to the speaker even if the listener turns off (or turns off) the video or audio of his/her own base.

### CITATION LIST

### Patent Literature

Patent Literature 1: JP 2002-351805 A

### SUMMARY OF INVENTION

### Technical Problem

However, in order for the user as a speaker to grasp the reaction of the user as a listener, the listener has to perform operation of consciously selecting a reaction icon indicating his/her own reaction. In addition, there is also a problem that it is difficult for the listener to convey his/her unconscious emotion to the speaker because of his/her unconsciousness.

The present invention has been made in view of the above circumstances, and an object of the present invention is to convey a user's own reaction to another base without the user in his/her own base performing operation of conveying his/her own reaction to a user in the another base.

### Solution to Problem

The invention according to claim 1 is a communication method executed by a communication terminal capable of making a call with another communication terminal in another base, the communication method including: an acquisition step of acquiring data related to a motion of a specific user from the motion of the specific user; an unconscious emotion portion detection step of detecting data of a specific unconscious emotion portion in which an unconscious emotion of the specific user has been expressed from the data related to the motion of the specific user; a reaction estimation step of estimating a reaction of the specific user on a basis of the data of the specific unconscious emotion portion detected by the unconscious emotion portion detection step by use of a reaction estimation model for estimating a reaction of a predetermined user with respect to data of a predetermined unconscious emotion portion in which an unconscious emotion of the predetermined user has been expressed; and a transmission step of transmitting reaction estimation result information related to the reaction of the specific user estimated by the reaction estimation step to the another communication terminal.

### Advantageous Effects of Invention

As described above, according to the present invention, there is an effect that a user's own reaction can be conveyed to another base without operation by the user in his/her own base.

### BRIEF DESCRIPTION OF DRAWINGS

FIG. 1 is a schematic diagram of a communication system according to an embodiment of the present invention.

FIG. 2 is an electrical hardware configuration diagram of a communication terminal.

FIG. 3 is a functional block diagram of the communication terminal.

FIG. 4 is a conceptual diagram illustrating time information.

FIG. 5 is a conceptual diagram illustrating reaction information.

FIG. 6 is a flowchart illustrating processing of machine learning.

FIG. 7 is a flowchart illustrating processing of estimating a reaction.

FIG. 8 is a diagram illustrating a profile image indicating absence of expression.

FIG. 9 is a diagram illustrating a profile image indicating a surprised expression.

FIG. 10 is a diagram illustrating reaction icons.

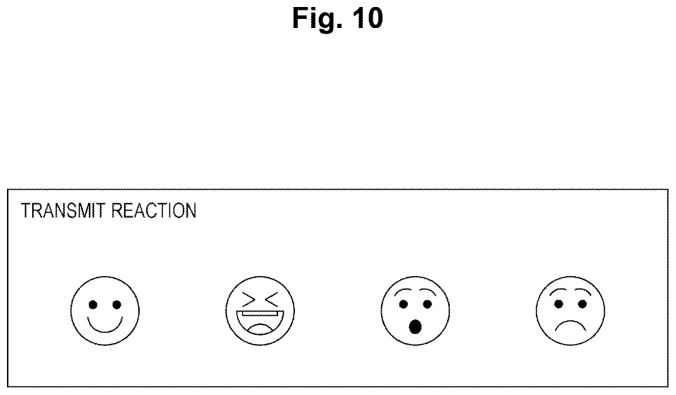

### DESCRIPTION OF EMBODIMENTS

Hereinafter, an embodiment of the present invention will be described with reference to the drawings.

### [Outline of System]

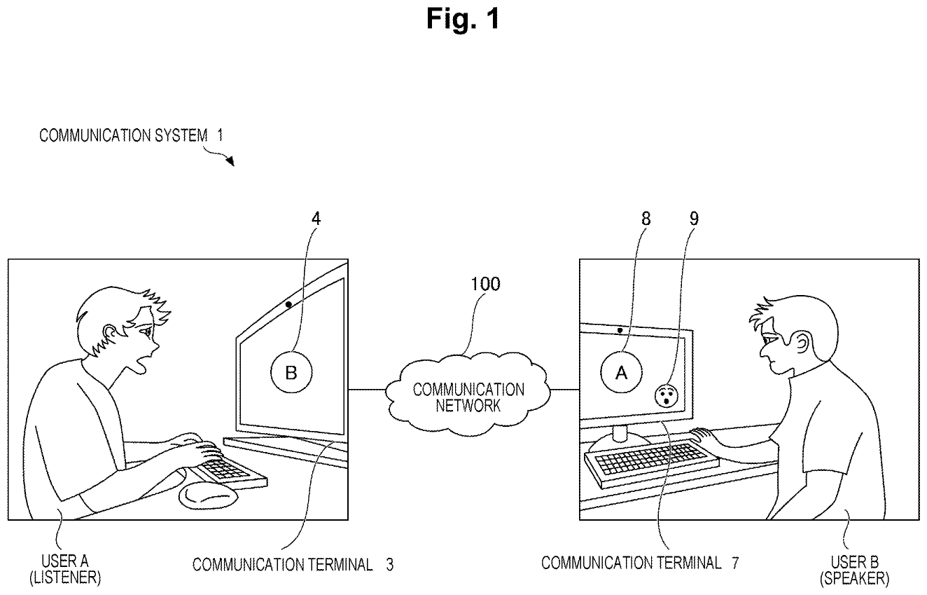

First, an outline of a communication system of the present embodiment will be described with reference to FIG. 1. Note that FIG. 1 is a schematic diagram of the communication system according to the embodiment of the present invention.

A communication system 1 illustrated in FIG. 1 is a system for making a remote call such as a television (video) conference. As illustrated in FIG. 1, the communication system 1 is constructed by a communication terminal 3 in a base of a user A and a communication terminal 7 in a base of a user B. The communication terminal 3 and the communication terminal 7 are general personal computers (PCs), and are communicably connected by a communication network 100 such as the Internet or a local area network (LAN). The connection form of the communication network 100 may be either wireless or wired.

The communication terminal 3 has a function of not transmitting data (audio data and video data) related to a motion of the user A in his/her own base to the communication terminal 7 during a call with the communication terminal 7. Similarly, the communication terminal 7 has a function of not transmitting data (audio data and video data) related to a motion of the user B in his/her own base to the communication terminal 3 during a call with the communication terminal 3.

FIG. 1 illustrates a state in which the users A and B do not show their own figures to each other. However, a profile image 4 of the user B is displayed on the communication terminal 3 side of the user A, and a profile image 8 of the user A is displayed on the communication terminal 7 side of the user B. Furthermore, although the users A and B talk with each other, FIG. 1 illustrates a state in which the user A has caused an Affect Burst of surprise when the user B talks to the user A. Affect Bursts are expressions of unconscious emotions such as expressions (gestures) and laughter, which include “ha-ha”, “heh”, and the like. Furthermore, a reaction icon 9 indicating a reaction of surprise of the user A is displayed on the communication terminal 7 on the user B side. The user B conveys the voice of the user B to the user A side, but the user A may or may not convey the voice of the user A to the user B side.

Note that, although two communication terminals 3 and 7 are illustrated in FIG. 1, three or more communication terminals may be used. Furthermore, on the communication terminal 3 side of the user A, the profile image 4 of the user B may not be displayed, and an expression of the user B may be displayed.

Furthermore, on the communication terminal 7 side of the user B, the profile image 8 of the user A may not be displayed, and a facial expression of the user A may or may not be displayed. However, in a case where the facial expression of the user A is not displayed, the significance of displaying the reaction icon 9 is improved.

Furthermore, the display forms of the profile images 4 and 8 and the reaction icon 9 illustrated in FIG. 1 are merely examples, and the profile images 4 and 8 and the reaction icon 9 may be displayed in other display forms such as different shapes, colors, and sizes, or addition of characters.

### [Hardware Configuration]

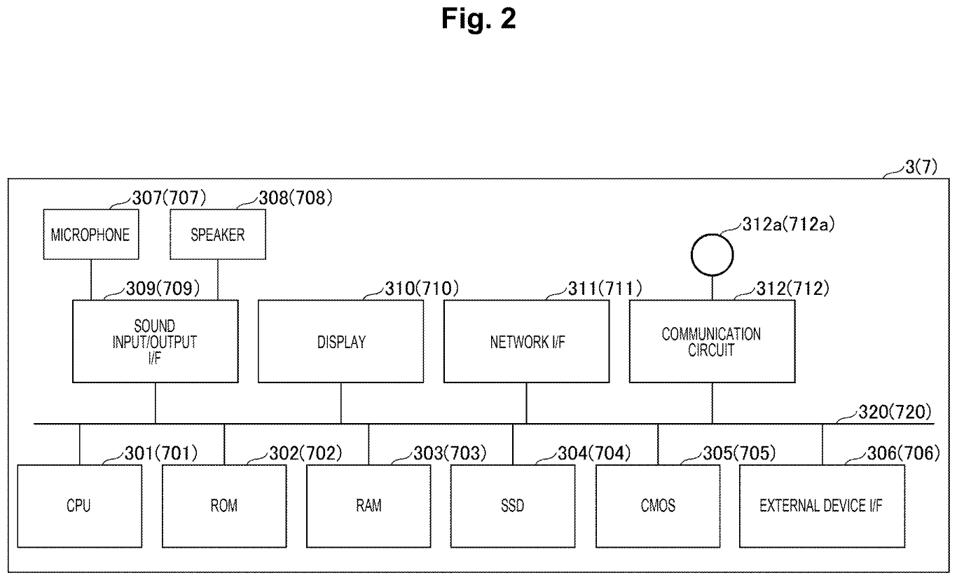

Next, an electrical hardware configuration of the communication terminal 3 will be described with reference to FIG. 2. FIG. 2 is an electrical hardware configuration diagram of the communication terminal.

As illustrated in FIG. 2, the communication terminal 3 includes a central processing unit (CPU) 301, a read only memory (ROM) 302, a random access memory (RAM) 303, a solid state drive (SSD) 304, a complementary metal oxide semiconductor (CMOS) sensor 305, and an external device interface (I/F) 306.

Among these components, the CPU 301 controls the operation of the entire communication terminal 3. The ROM 302 stores a program used for operating the CPU 301 and a program used for driving the CPU 301, such as IPL. The RAM 303 is used as a work area of the CPU 301.

The SSD 304 reads or writes various data such as a communication terminal program under the control of the CPU 301. Note that a storage device such as a hard disk drive (HDD) may be used instead of the SSD.

The CMOS sensor 305 is a type of built-in imaging means that images a subject or the like under the control of the CPU 301 to obtain video (image) data. Note that an imaging element such as a charge coupled device (CCD) sensor may be used instead of the CMOS sensor.

The external device I/F 306 is an interface for connecting various external devices. The external devices in this case are an external display as an example of a display means, a mouse, a keyboard, or a microphone as an example of an input means, a printer or a speaker as an example of an output means, a universal serial bus (USB) memory as an example of a storage means, and the like.

Furthermore, the communication terminal 3 includes a microphone 307, a speaker 308, a sound input/output I/F 309, a display 310, a network I/F 311, a communication circuit 312, and an antenna 312a of the communication circuit 312.

Among these components, the microphone 307 is a built-in circuit that converts sound into an electrical signal. The speaker 308 is a built-in circuit that converts an electrical signal into physical vibration to generate sound such as music and voice. The sound input/output I/F 309 is a circuit that processes input and output of a sound signal between the microphone 307 and the speaker 308 under the control of the CPU 301.

The display 310 is a type of display means such as liquid crystal or organic electro luminescence (EL) that displays an image of a subject, various icons, and the like.

The network I/F 311 is a circuit for transmitting and receiving data and the like to and from a communication terminal other than the communication terminal 3 or a server via the communication network 100.

The communication circuit 312 is a circuit for performing data communication with another device with the antenna 312a by use of a short-range wireless communication technology such as near field communication (NFC) or Bluetooth (registered trademark).

In addition, the communication terminal 3 includes a bus line 320. The bus line 320 is an address bus, a data bus, or the like for electrically connecting each component such as the CPU 301 illustrated in FIG. 2.

Note that the electrical hardware configuration of the communication terminal 7 is similar to the electrical hardware configuration of the communication terminal 3, and thus, in FIG. 2, reference numerals 300 series are merely replaced with reference numerals 700 series. Therefore, the description of the electrical hardware configuration of the communication terminal 7 is omitted.

### [Functional Configuration of Embodiment]

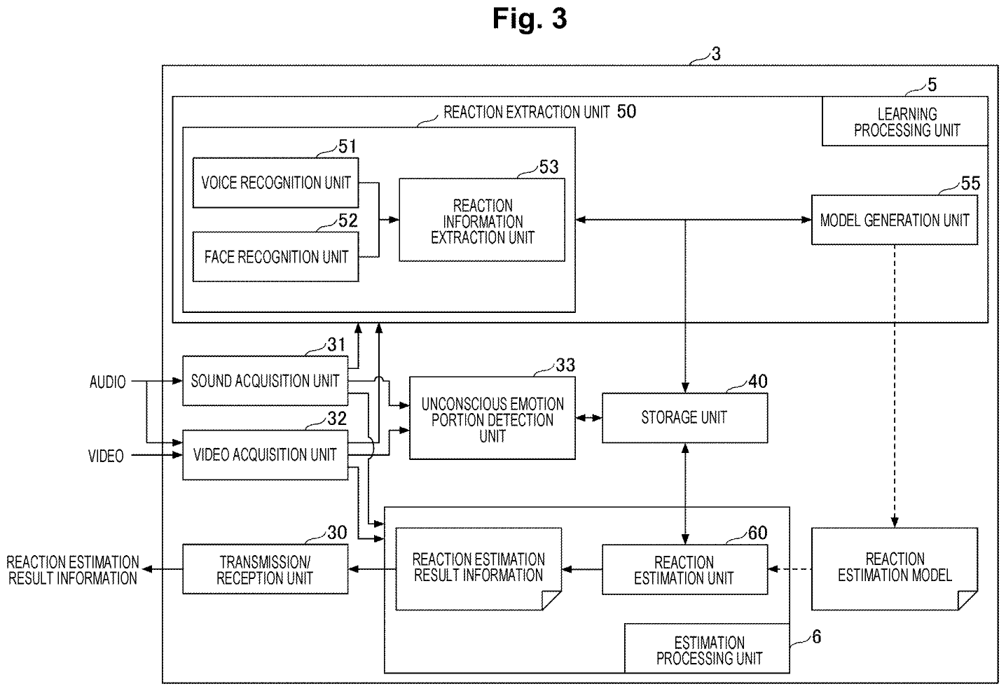

Next, a functional configuration of the present embodiment will be described with reference to FIGS. 2 to 5. FIG. 3 is a functional block diagram of a communication terminal.

As illustrated in FIG. 3, the communication terminal 3 includes a learning processing unit 5, an estimation processing unit 6, a transmission/reception unit 30, a sound acquisition unit 31, a video acquisition unit 32, and an unconscious emotion portion detection unit 33. Each of these units is a function or a means implemented by one of the components illustrated in FIG. 2 being operated by a command from the CPU 301 according to a program developed on the RAM 303 from the SSD 304. In addition, the communication terminal 3 includes a storage unit 40 constructed by the RAM 303 or the SSD 304 illustrated in FIG. 2.

Among these components, the learning processing unit 5 performs machine learning processing so as to be able to estimate a reaction of a user with respect to data of an unconscious emotion portion (a portion where an Affect Burst occurs) of each of sound data acquired by the sound acquisition unit 31 and video data acquired by the video acquisition unit 32. The estimation processing unit 6 performs processing of estimating a reaction of a specific user from data of a specific unconscious emotion portion detected by the unconscious emotion portion detection unit 33 by use of a reaction estimation model obtained by machine learning by the learning processing unit 5.

The transmission/reception unit 30 of the communication terminal 3 transmits and receives various data to and from the communication terminal 7 via the communication network 100. For example, the transmission/reception unit 30 receives, from the communication terminal 7, audio data indicating contents uttered by the user B, video (image) data indicating a facial expression of the user B, and the like. Furthermore, the transmission/reception unit 30 receives audio data and video data of the user B from the communication terminal 7.

The sound acquisition unit 31 acquires audio data indicating contents uttered by a user collected by the microphone 307. The video acquisition unit 32 acquires video data indicating a facial expression or the like of the user captured by the CMOS sensor 305. Note that a motion made by the user with his/her mouth or nose and a motion made by the user changing his/her facial expression are examples of a motion of the user. Furthermore, the audio data and the video data in this case are examples of data related to the motion of the user. However, the data related to the motion of the user is only required to be at least one of the audio data and the video data.

The unconscious emotion portion detection unit 33 detects data of an unconscious emotion portion in which an unconscious emotion of the user as an acquisition source has been expressed, from the audio data acquired by the sound acquisition unit 31 and the video data acquired by the video acquisition unit 32. An extraction method is disclosed in Reference Literature 1.

Reference Literature 1: B. B. Turker, S. Marzban, M. T. Sezgin, Y. Yemez and E. Erzin, “Affect burst detection using multi-modal cues”, 2015 23nd Signal Processing and Communications Applications Conference (SIU), Malatya, Turkey, 2015, pp. 1006-1009.

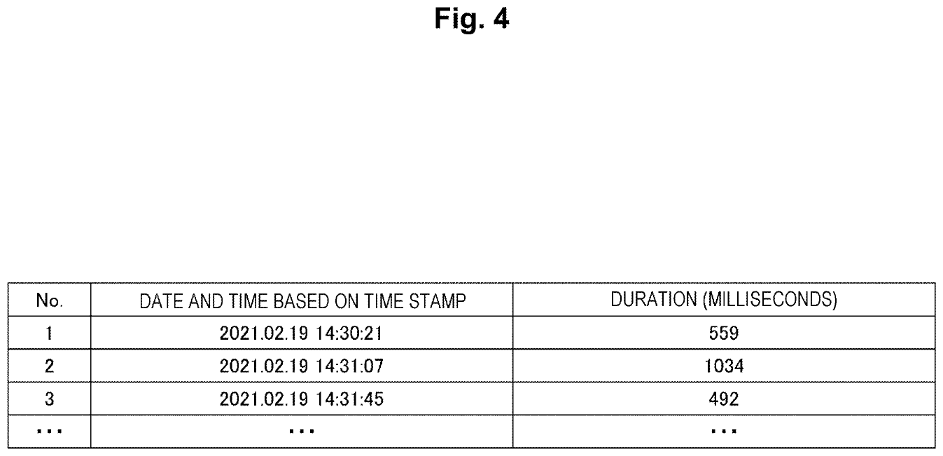

In addition, the unconscious emotion portion detection unit 33 stores, in the storage unit 40, time information including a date and time when the detection of the data of the unconscious emotion portion in the audio data acquired by the sound acquisition unit 31 is started, and a duration from the date and time to a date and time when the acquisition of the data of the unconscious emotion portion is temporarily ended. FIG. 4 is a conceptual diagram illustrating time information. As illustrated in FIG. 4, the time information is information in which a date and time (date and time based on a time stamp) when the detection of data of an unconscious emotion portion is started and a duration (milliseconds) from the date and time to a date and time when the acquisition of the data of the unconscious emotion portion is temporarily ended are associated in order of reference numbers (time series). Furthermore, the unconscious emotion portion detection unit 33 similarly processes the video data acquired by the video acquisition unit 32. Note that all the sound data acquired by the sound acquisition unit 31 and all the video data acquired by the video acquisition unit 32 are stored in the storage unit 40.

Subsequently, referring back to FIG. 3, the learning processing unit 5 includes a reaction extraction unit 50 and a model generation unit 55.

The reaction extraction unit 50 reads the data of the unconscious emotion portion corresponding to the time information stored in the storage unit 40 out of the audio data and the video data stored in the storage unit 40, and extracts a reaction of the user from the unconscious emotion portion. In order to perform this processing, the reaction extraction unit 50 further includes a voice recognition unit 51, a face recognition unit 52, and a reaction information extraction unit 53.

Among these components, the voice recognition unit 51 recognizes a voice indicating contents uttered by the user with respect to the data of the unconscious emotion portion. The face recognition unit 52 recognizes a facial expression of the user with respect to the data of the unconscious emotion portion.

The reaction information extraction unit 53 then extracts reaction information indicating the reaction of the user in the unconscious emotion portion from the voice recognized by the voice recognition unit 51. Furthermore, the reaction information extraction unit 53 extracts reaction information indicating the reaction of the user in the unconscious emotion portion from the facial expression recognized by the face recognition unit 52. An extraction method is disclosed, for example, in Reference Literature 2.

Reference Literature 2: B. T. Nguyen, M. H. Trinh, T. V. Phan and H. D. Nguyen, “An efficient real-time emotion detection using camera and facial landmarks”, 2017 Seventh International Conference on Information Science and Technology (ICIST), Da Nang, 2017, pp. 251-255.

Reference Literature 2 discloses a method of extracting feature points from face images and performing machine learning on patterns of the feature points to perform estimation.

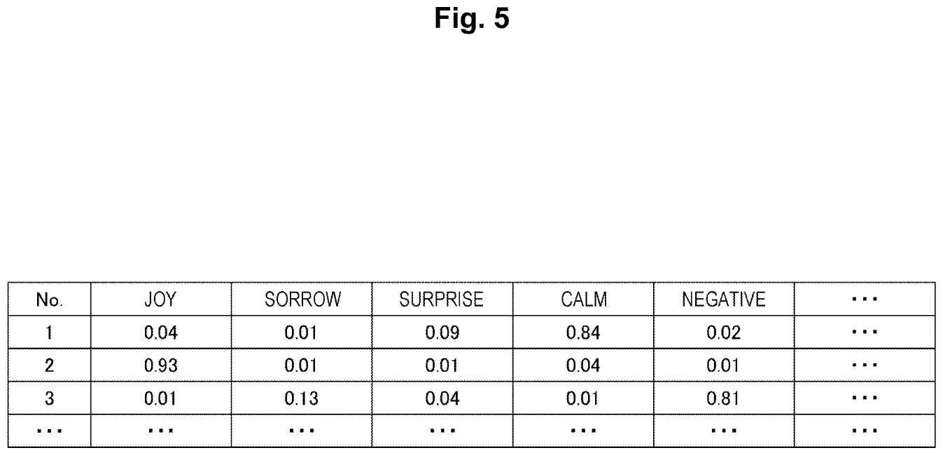

FIG. 5 is a conceptual diagram illustrating reaction information. As illustrated in FIG. 5, the reaction information is information indicating percentage scores of joy, sorrow, surprise, normality, negative (negative), and the like in order of reference numbers (time series).

Furthermore, the model generation unit 55 generates the reaction estimation model (Affect Burst-reaction model) by performing machine learning such that a reaction of a user such as joy can be estimated on the basis of data of an unconscious emotion portion. That is, the model generation unit 55 performs machine learning using the reaction information extracted by the reaction information extraction unit 53 as a correct answer label and using the data of the unconscious emotion portion as input data. For example, the model generation unit 55 extracts respective feature amounts from the audio and the video of the unconscious emotion portion and performs learning with a convolutional neural network (CNN). Note that acquisition sources of data of unconscious emotion portions used for input data by the model generation unit 55 are predetermined users including the user A.

Next, the estimation processing unit 6 includes a reaction estimation unit 60. The reaction estimation unit 60 estimates a reaction of a specific user who is the user A on the basis of the data of the unconscious emotion portion detected by the unconscious emotion portion detection unit 33 by use of the reaction estimation model. In this case, the reaction estimation unit 60 estimates the reaction of the user A on the basis of the data of the specific unconscious emotion portion corresponding to the time information stored in the storage unit 40 in the data related to the motion of the user A (audio data and video data).

Reaction estimation result information related to the reaction of the user A estimated by the reaction estimation unit 60 is then transmitted to the communication terminal 7 by the transmission/reception unit 30 as described above. As illustrated in FIG. 1, the reaction estimation result information is information for the communication terminal 7 of the user B to display the reaction icon 9 indicating the reaction of the user A. Note that the reaction estimation result information is used again as the above-described reaction information for machine learning (see FIG. 4).

### Processing or Operation of Embodiment

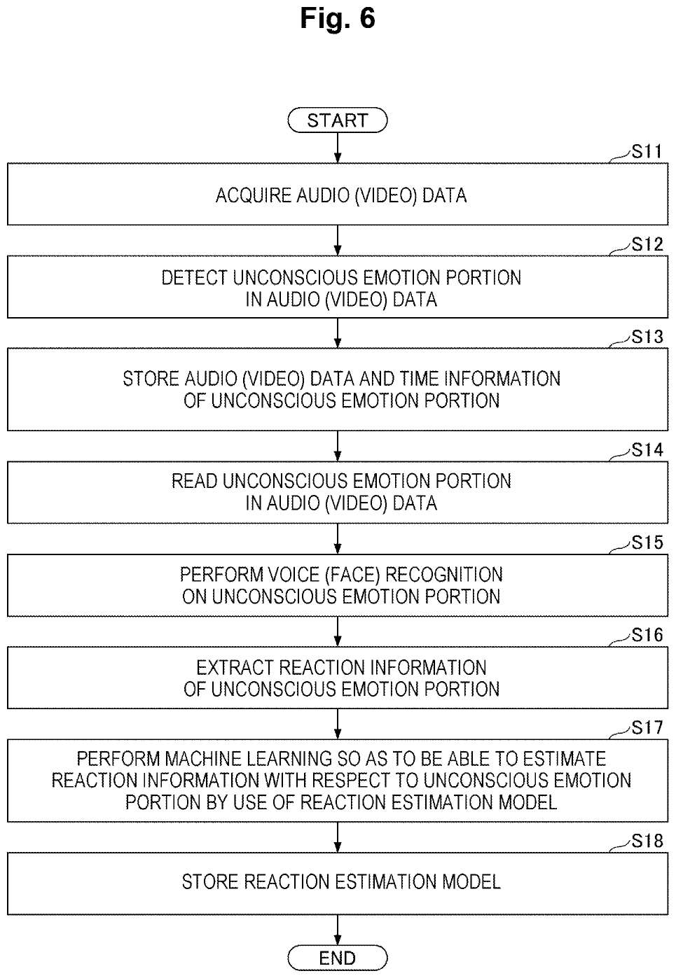

Next, processing or operation of the present embodiment will be described with reference to FIGS. 6 to 9.

### <Processing of Machine Learning>

First, processing of machine learning executed by the communication terminal 3 will be described with reference to FIG. 6. FIG. 6 is a flowchart illustrating the processing of machine learning.

As illustrated in FIG. 6, the sound acquisition unit 31 acquires audio data indicating contents uttered by the user A with his/her mouth or the like, and the video acquisition unit 32 acquires video data indicating a facial expression of the user A (S11).

Next, the unconscious emotion portion detection unit 33 detects an unconscious emotion portion in the audio (video) data (S12). The unconscious emotion portion detection unit 33 then stores the audio (video) data and time information of the unconscious emotion portion in the storage unit 40 (S13).

Next, the reaction extraction unit 50 reads data of the unconscious emotion portion in the audio (video) data on the basis of the time information stored in the storage unit 40 (S14). The voice recognition unit 51 performs voice recognition on the data of the unconscious emotion portion, and the face recognition unit 52 performs facial expression recognition on the data of the unconscious emotion portion (S15). Furthermore, the reaction information extraction unit 53 extracts reaction information of the unconscious emotion portion on the basis of a recognition result by the voice recognition unit 51 and a recognition result by the face recognition unit 52 (S16).

Next, the model generation unit 55 performs machine learning so as to be able to estimate reaction information with respect to data of an unconscious emotion portion by use of a reaction estimation model (S17). The model generation unit 55 then stores data of the reaction estimation model after machine learning in the storage unit 40.

As described above, the processing of machine learning executed by the communication terminal 3 ends.

### <Processing of Estimating Reaction>

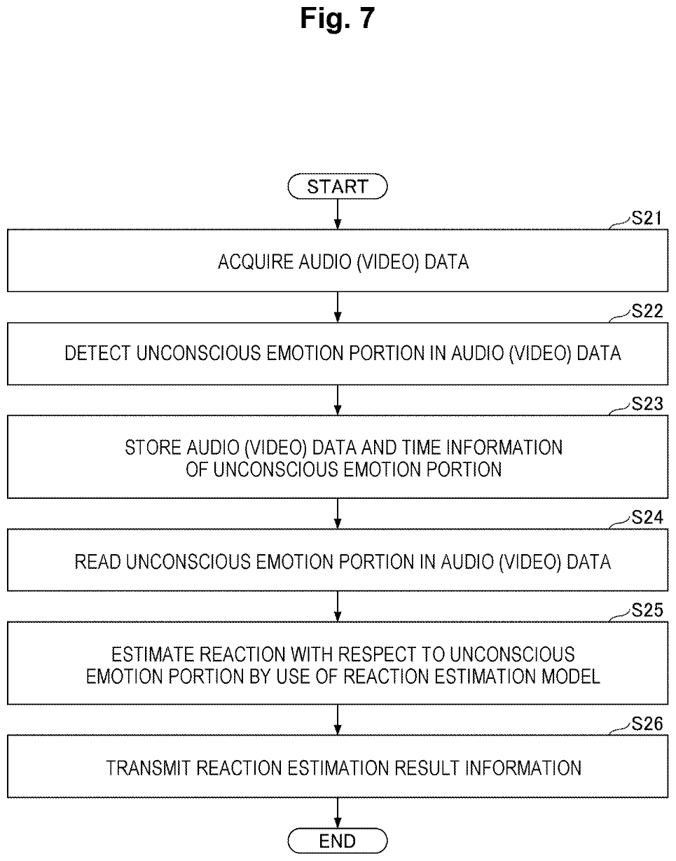

Subsequently, processing of estimating a reaction of the user A executed by the communication terminal 3 will be described with reference to FIG. 7. FIG. 7 is a flowchart illustrating processing of estimating a reaction. Note that steps S21 to S24 are processing similar to steps S11 to S14 described above.

As illustrated in FIG. 7, the sound acquisition unit 31 acquires audio data indicating contents uttered by the user A with his/her mouth or the like, and the video acquisition unit 32 acquires video data indicating a facial expression of the user A (S21).

Next, the unconscious emotion portion detection unit 33 detects an unconscious emotion portion in the audio (video) data (S22). The unconscious emotion portion detection unit 33 then stores the audio (video) data and time information of the unconscious emotion portion in the storage unit 40 (S23).

Next, the reaction extraction unit 50 reads data of the unconscious emotion portion in the audio (video) data on the basis of the time information stored in the storage unit 40 (S24).

Subsequently, the reaction estimation unit 60 estimates a reaction of the user A with respect to the data of the unconscious emotion portion by use of the machine-learned reaction estimation model (S25).

The transmission/reception unit 30 transmits reaction estimation result information related to the reaction of the user A estimated by the reaction estimation unit 60 to the communication terminal 7 (S26).

As a result, as illustrated in FIG. 1, on the communication terminal 7 side of the user B, the reaction icon 9 indicating the reaction of the user A is displayed on a display 710.

As described above, the processing of estimating a reaction executed by the communication terminal 3 ends. Note that, in <Processing of Machine Learning> described above, voice (face) recognition is performed (see S15), whereby the reaction estimation model is generated (see S17). On the other hand, in <Processing of Estimating Reaction>, voice (face) recognition is not performed, and the reaction of the user A is estimated directly from the data of the unconscious emotion portion by use of the reaction estimation model (S25).

### Main Effects of Present Embodiment

As described above, according to the present embodiment, the communication terminal 3 can estimate a reaction of the user A on the basis of a voice uttered by the user A and a facial expression of the user A, and transmit reaction estimation result information to the communication terminal 7. As a result, there is an effect that the user A can convey the reaction of the user A to a partner (user B) in another base without performing operation of conveying the user A's reaction to the user B.

### [Supplement]

The present invention is not limited to the above-described embodiment, and may be configured or processed (operated) as described below.

(1) Each of the communication terminals 3 and 7 of the present invention can also be implemented by a computer and a program, and the program can be recorded in a recording medium or provided through a communication network.

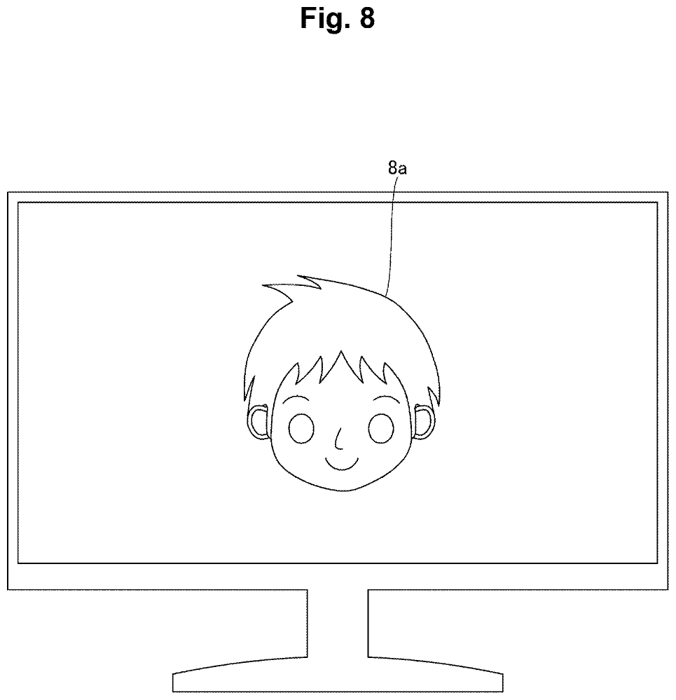

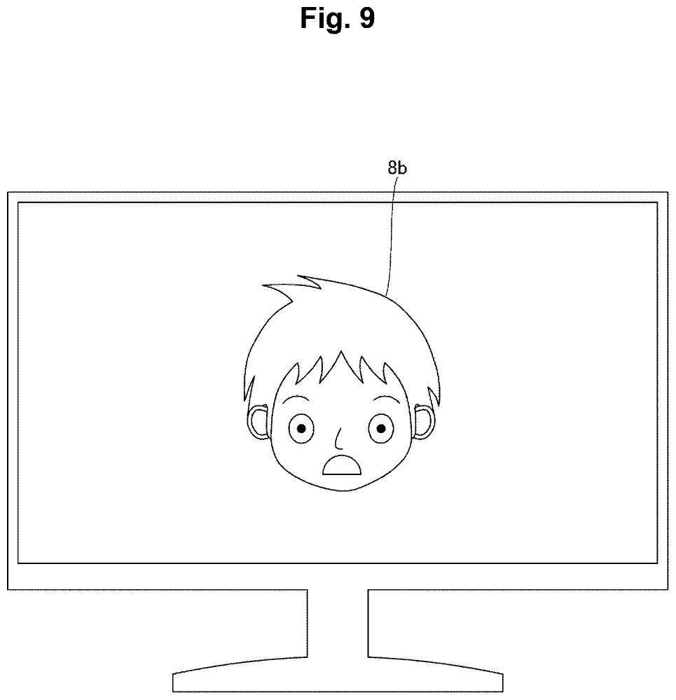

(2) In the above embodiment, the reaction icon 9 is displayed as illustrated in FIG. 1, but the present invention is not limited thereto. For example, in the communication terminal 7, a profile image 8a of the user A as illustrated in FIG. 8 may be initially displayed, and the communication terminal 7 may switch to and display a profile image 8b in a display mode indicating surprise as illustrated in FIG. 9 when reaction estimation result information is transmitted from the communication terminal 3.

(3) The profile image described above is an example of a user identification image. The user identification image also includes an avatar.

(4) In the above embodiment, PCs are shown as examples of communication terminals, but the PCs include a desktop personal computer and a notebook personal computer. Furthermore, other examples of the communication terminals include a smart watch, a car navigation device, and the like.

(5) Each of the CPUs 301 and 701 may be not only a single CPU but also a plurality of CPUs.

### REFERENCE SIGNS LIST

1 Communication system
3 Communication terminal
4 Profile image (of user B)
5 Learning processing unit
6 Estimation processing unit
7 Communication terminal (example of another communication terminal)
8 Profile image (of user A)
9 Reaction icon
30 Transmission/reception unit (example of transmission means)
31 Sound acquisition unit (example of acquisition means)
32 Video acquisition unit (example of acquisition means)
33 Unconscious emotion portion detection unit (example of unconscious emotion portion detection means)
40 Storage unit (example of storage means)
50 Reaction extraction unit (example of reaction extraction means)
51 Voice recognition unit (example of voice recognition means and example of recognition means)
52 Face recognition unit (example of face recognition means and example of recognition means)
53 Reaction information extraction unit
55 Model generation unit (example of model generation means)
60 Reaction estimation unit (example of reaction estimation means)
710 Display (example of display means)

1. A communication method executed by a communication terminal that includes a memory and a processor configured to be capable of making a call with another communication terminal in another base, the communication method comprising:
acquiring data related to a motion of a specific user from the motion of the specific user;
detecting data of a specific unconscious emotion portion in which an unconscious emotion of the specific user has been expressed from the data related to the motion of the specific user;
estimating a reaction of the specific user on a basis of the data of the specific unconscious emotion portion detected by use of a reaction estimation model for estimating a reaction of a predetermined user with respect to data of a predetermined unconscious emotion portion in which an unconscious emotion of the predetermined user has been expressed; and
transmitting reaction estimation result information related to the estimated reaction of the specific user to said another communication terminal.

2. The communication method according to claim 1, wherein the memory of the communication terminal stores time information including a date and time when detection of the data of the specific unconscious emotion portion is started and a duration from the date and time to a date and time when the detection is temporarily ended, and
the estimating includes processing of estimating the reaction of the specific user on the basis of the data of the specific unconscious emotion portion corresponding to the time information stored in the memory in the data related to the motion of the specific user.

3. The communication method according to claim 1, wherein a display mode of a reaction mark displayed by said another communication terminal changes or a display mode of a user identification image of the specific user displayed by said another communication terminal changes according to a reaction estimation result indicated by the reaction estimation result information.

4. The communication method according to claim 1, wherein the acquiring includes processing of acquiring data related to a motion of the predetermined user from the motion of the predetermined user,
the detecting includes processing of detecting the data of the predetermined unconscious emotion portion in which the unconscious emotion of the predetermined user has been expressed from the data related to the motion of the predetermined user, and
the communication method further comprising:
recognizing at least one of a voice indicating contents uttered by the predetermined user and a facial expression of the predetermined user with respect to the data of the predetermined unconscious emotion portion;
extracting reaction information indicating the reaction of the predetermined user in the predetermined unconscious emotion portion on a basis of a recognition result by the recognizing; and
generating the reaction estimation model by performing machine learning so as to be able to estimate the reaction of the predetermined user indicated by the reaction information with respect to the data of the predetermined unconscious emotion portion.

5. The communication method according to claim 4, wherein in a case where the data related to the motion of the predetermined user is audio data indicating contents of an utterance of the predetermined user, the recognizing includes processing of recognizing the voice of the predetermined user with respect to the data of the predetermined unconscious emotion portion, and
in a case where the data related to the motion of the predetermined user is video data indicating an expression of the predetermined user, the recognizing includes processing of recognizing the facial expression of the predetermined user with respect to the data of the predetermined unconscious emotion portion.

6. The communication method according to claim 1, wherein the communication terminal has a function of not transmitting the data related to the motion of the specific user in an own base of the specific user to said another communication terminal during a call with said another communication terminal.

7. A communication terminal capable of making a call with another communication terminal in another base, the communication terminal comprising:
a memory; and
a processor configured to:
acquire data related to a motion of a specific user from the motion of the specific user;
detect data of a specific unconscious emotion portion in which an unconscious emotion of the specific user has been expressed from the data related to the motion of the specific user;
estimate a reaction of the specific user from the data of the specific unconscious emotion portion detected by use of a machine-learned reaction estimation model for estimating a reaction of a predetermined user with respect to data of a predetermined unconscious emotion portion in which an unconscious emotion of the predetermined user has been expressed; and
transmit reaction estimation result information related to the estimated reaction of the specific user to said another communication terminal.

8. (canceled)

9. A non-transitory computer-readable recording medium having computer-readable instructions stored thereon, which, when executed, cause a communication terminal that includes a computer including a memory and a processor configured to be capable of making a call with another communication terminal in another base, to execute a method, the method comprising:
acquiring data related to a motion of a specific user from the motion of the specific user;
detecting data of a specific unconscious emotion portion in which an unconscious emotion of the specific user has been expressed from the data related to the motion of the specific user;
estimating a reaction of the specific user on a basis of the data of the specific unconscious emotion portion detected by use of a reaction estimation model for estimating a reaction of a predetermined user with respect to data of a predetermined unconscious emotion portion in which an unconscious emotion of the predetermined user has been expressed; and
transmitting reaction estimation result information related to the estimated reaction of the specific user to said another communication terminal.
